(19) United States
(12) Patent Application Publication
(10) Pub. No.: US 2017/0214667 A1
(43) Pub. Date: Jul. 27, 2017

(54) COMMUNICATION DEVICE

(71) Applicant: FUJITSU LIMITED, Kawasaki-shi (JP)

(72) Inventor: Isamu Fukuda, Yokohama (JP)

(73) Assignee: FUJITSU LIMITED, Kawasaki-shi (JP)

(21) Appl. No.: 15/362,042

(22) Filed: Nov. 28, 2016

(30) Foreign Application Priority Data
Jan. 27, 2016 (JP) 2016-012996

(51) Int. Cl. H04L 29/06; H04W 12/06; H04L 12/741

(52) U.S. Cl. CPC H04L 63/0485; H04L 45/74; H04W 12/06; H04L 63/06

(57) ABSTRACT

A communication device includes, a packet transmission unit that generates and transmits a packet including a first bit string, which is a first part of a bit string of a sequence number indicating an order of transmission of the packet, in a sequence number region in the packet corresponding to sequence number information, a second bit string, which is a second part other than the first part of the bit string of the sequence number, in an extension region other than the sequence number region, and authentication information, which is generated based on the sequence number, in an authentication information region corresponding to the authentication information, and a packet reception unit that receives the packet including the sequence number and the authentication information from another communication device, and authenticates the received packet based on the sequence number and the authentication information included in the received packet.

### CROSS-REFERENCE TO RELATED APPLICATION

This application is based upon and claims the benefit of priority of the prior Japanese Patent Application No. 2016-012996, filed on Jan. 27, 2016, the entire contents of which are incorporated herein by reference.

### FIELD

The present invention relates to a communication device.

### BACKGROUND

In recent years, a communication protocol, such as security architecture for Internet protocol (IPsec), having functions of preventing data tampering and concealing data attracts attention.

A communication device that performs communication using IPsec performs authentication to determine whether or not a received packet is an invalid packet. The communication device having received the packet performs the authentication based on a sequence number added to the packet by a communication device serving as a transmission source and authentication information generated from the sequence number. Specifically, the communication device on the reception side generates the authentication information from the sequence number in the received packet, and determines whether or not the generated authentication information matches the authentication information in the received packet. The sequence number is a numerical value that is incremented every time the communication device serving as the transmission source transmits the packet, and represents the number of times of the transmission of the packet.

In addition, the communication device that performs the communication using IPsec updates an encryption key for encrypting data of the packet. The encryption key is used until the sequence number reaches the upper limit value, and is newly updated at a timing at which the sequence number returns to an initial value.

The sequence number in IPsec is sometimes represented in 32 bits (hereinafter referred to as a 32-bit mode) and is sometimes represented in 64 bits (hereinafter referred to as a 64-bit mode). In either mode, the authentication information is generated based on the sequence number, and is added to the packet. However, while all bits of the sequence number are added to the packet in the 32-bit mode, only lower 32 bits are added to the packet in the 64-bit mode, and the remaining upper 32 bits are internally managed by incrementing the upper 32 bits based on occurrence of an overflow of the lower bit in the packet by the communication devices on the transmission side and the reception side.

A technique related to the sequence number is disclosed in Japanese Laid-open Patent Publication No. H6-205045.

### SUMMARY

According to an aspect of the embodiments, a communication device includes, a packet transmission unit that generates and transmits a packet including a first bit string, which is a first part of a bit string of a sequence number indicating an order of transmission of the packet, in a sequence number region in the packet corresponding to sequence number information, a second bit string, which is a second part other than the first part of the bit string of the sequence number, in an extension region other than the sequence number region, and authentication information, which is generated based on the sequence number, in an authentication information region corresponding to the authentication information, and a packet reception unit that receives the packet including the sequence number and the authentication information from another communication device, and authenticates the received packet based on the sequence number and the authentication information included in the received packet.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating an example of the configuration of a communication system 10.

FIG. 2 is a view illustrating an example of the configuration of the communication device 200.

FIG. 3 is a view illustrating an example of the sequence of the packet transmission and reception in the communication device.

FIG. 4 is a view illustrating an example of a process flowchart of each of the transmission-side session establishment process and the reception-side session establishment process.

FIG. 5 is a view illustrating an example of a process flowchart of the packet transmission process.

FIG. 6 is a view illustrating an example of the sequence number in the first extension mode.

FIG. 7 is a view illustrating examples of information elements included in the packet in the 32-bit mode and the first extension mode.

FIG. 8 is a view illustrating an example of a process flowchart of the packet reception process.

FIG. 9 is a view illustrating the case where the fragmentation is performed and the case where the fragmentation is not performed in the packet transmission between the communication devices.

FIG. 10 is a view illustrating an example of a process flowchart of the packet transmission process in the second extension mode

FIG. 11 is a view illustrating an example of the sequence number in the second extension mode.

FIG. 12 is a view illustrating examples of the information elements included in the packet in the case where the fragmentation is performed and the case where the fragmentation is not performed in the second extension mode.

FIG. 13 is a view illustrating an example of the configuration of the communication device 200

FIG. 14 is a view illustrating an example of a process flowchart of the packet transmission process in the third extension mode.

FIG. 15 is a view illustrating an example of the extended sequence number in the third extension mode.

FIG. 16 is a view illustrating examples of the information elements included in the packet in the 32-bit mode (or the 64-bit mode) and the third extension mode.

FIG. 17 is a view illustrating an example of a process flowchart of the packet reception process.

### DESCRIPTION OF EMBODIMENTS

In the 32-bit mode, when large-capacity high-speed communication is performed, the amount of time until the sequence number reaches the upper limit value is reduced, and the update of the encryption key is frequently performed. A processing load is high during the update process of the encryption key, and hence there are cases where the communication device is not able to perform another communication. In addition, it is not possible to perform the communication until exchange of the encryption key is completed. Thus, in the 32-bit mode, a state in which it is not possible to frequently perform the communication occurs.

In the 64-bit mode, when congestion occurs in a communication network and a large number of packets do not reach the communication device serving as a transmission destination, there are cases where a mismatch occurs in the upper 32 bits that are incremented and managed by the communication devices on the transmission source and the transmission destination. When the numerical numbers of the upper 32 bits that are managed by the communication devices on the transmission source and the transmission destination are different from each other, the packet received thereafter causes an authentication error and the packet is successively abandoned, and hence it is not possible to perform the communication.

<Example of Configuration of Communication System>

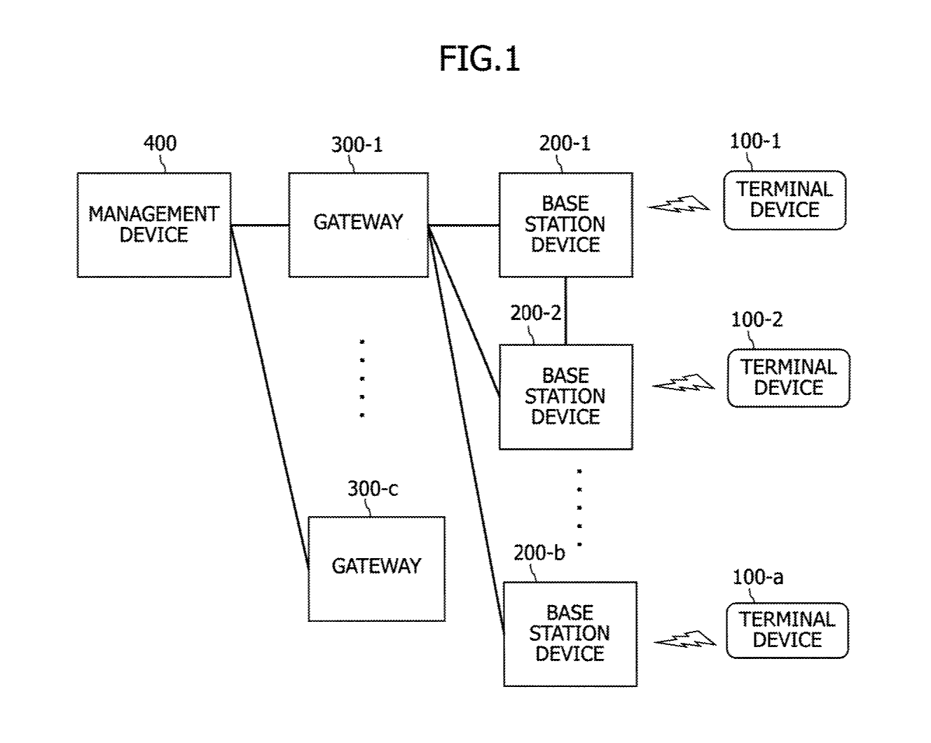

FIG. 1 is a view illustrating an example of the configuration of a communication system 10. The communication system 10 has terminal devices 100-1 to 100-a, base station devices 200-1 to 200-b, gateways 300-1 to 300-c, and a management device 400. The communication system 10 is, e.g., a communication system that provides communication to the terminal devices 100-1 to 100-a because the terminal devices 100-1 to 100-a receive services of networks such as the Internet. The communication system 10 is, e.g., a long term evolution (LTE) communication standard-compliant communication system.

When the terminal device 100 receives services, the terminal device 100 performs, e.g., communication with the Internet (not illustrated) connected to the management device 400. The base station device 200, the gateway 300, and the management device 400 relay packets transmitted and received by the terminal device 100 to thereby implement the communication of the terminal device 100. The management device 400, the gateway 300, and the base station device 200 are connected to each other via a dedicated line or a network such as an intranet. The terminal device 100 and the base station device 200 are connected via radio communication.

Thus, communication equipment constituting the communication system 10 performs the communication with the Internet. The Internet is a network that is open to the public so that there is a possibility that data of the packet obtained via the Internet is tampered with or stolen by others. To cope with this, there are cases where the communication equipment performs the communication to which a protocol having functions of preventing the data tampering and concealing the data (e.g., IPsec) is applied. In the communication to which IPsec is applied, security is improved by performing an authentication process that uses a sequence number indicative of the order of transmission of the packet and encryption of a data part.

In IPsec, when the sequence number reaches the upper limit value, a session is newly established. In a process for establishing the session, the generation of an encryption key or an authentication key is performed so that a processing load is high and there are cases where it is not possible to perform another communication. In addition, until the new session is established, it is not possible to perform the communication. In the case where the sequence number has 32 bits (32-bit mode), when high-speed communication having a speed that exceeds, e.g., 100 gigabits per second (Gbps) is performed, the sequence number reaches the upper limit value in about 30 seconds. Accordingly, a time period in which it is not possible to perform the communication occurs at time intervals of about 30 seconds.

In the case where the sequence number has 64 bits (64-bit mode), the upper 32 bits of the sequence number are not included in the packet, and hence the upper 32 bits are internally managed by incrementing the upper 32 bits by communication devices that transmit and receive the packet. In this case, for example, when a mismatch occurs in numerical values of the upper 32 bits managed by the communication devices due to temporary interruption of the communication, the communication devices fail to authenticate, and a time period in which it is not possible to perform the communication occurs.

To cope with this, in the communication device in the communication system 10, for example, the sequence number in the 32-bit mode is extended, and a bit string obtained by the extension is included in a region (hereinafter referred to as an extension region) in the packet that is not a region corresponding to the sequence number. With this, the amount of time until the sequence number reaches the upper limit value is increased, and the time period in which it is not possible to perform the communication is reduced. In addition, all of the bit strings of the sequence number including the bit string obtained by the extension are included in the packet and transmitted, and hence the mismatch of the sequence number between the communication device on a transmission side and the communication device on a reception side is prevented from occurring, and the time period in which it is not possible to perform the communication is prevented from occurring.

Hereinbelow, a description will be made by using the base station device 200 as an example of the communication device, but each of the management device 400, the gateway 300, and the terminal device 100 can also be the communication device.

### First Embodiment

First, a first embodiment will be described.

In the first embodiment, the sequence number indicative of the order of transmission of the packet is extended by 8 bits from 32 bits in the 32-bit mode to 40 bits. When the communication device 200 receives the packet from another communication device, the communication device 200 authenticates the received packet based on the sequence number and authentication information included in the received packet. In addition, the communication device 200 includes a first bit string that is part of the bit string indicative of the sequence number in a region in which the sequence number of the packet in the 32-bit mode is included (hereinafter referred to as a sequence number region) when the packet to be transmitted is generated. Further, the communication device 200 includes a second bit string that has bits other than the first bit string in the bit string indicative of the sequence number in a region other than the sequence number region (extension region). In the first embodiment, a region of lower 8 bits of a region in which an SPI number of the packet in the 32-bit mode is included (hereinafter referred to as an SPI number region) is used as the extension region. Subsequently, the communication device 200 includes the authentication information generated based on the sequence number in a region in which the authentication information of the packet in the 32-bit mode is included (hereinafter referred to as an authentication information region), and transmits the generated packet.

Note that a sequence number mode that extends the sequence number and includes the bit string obtained by the extension in part of the SPI number region in the first embodiment is referred to as a first extension mode.

<Example of Configuration of Communication Device>

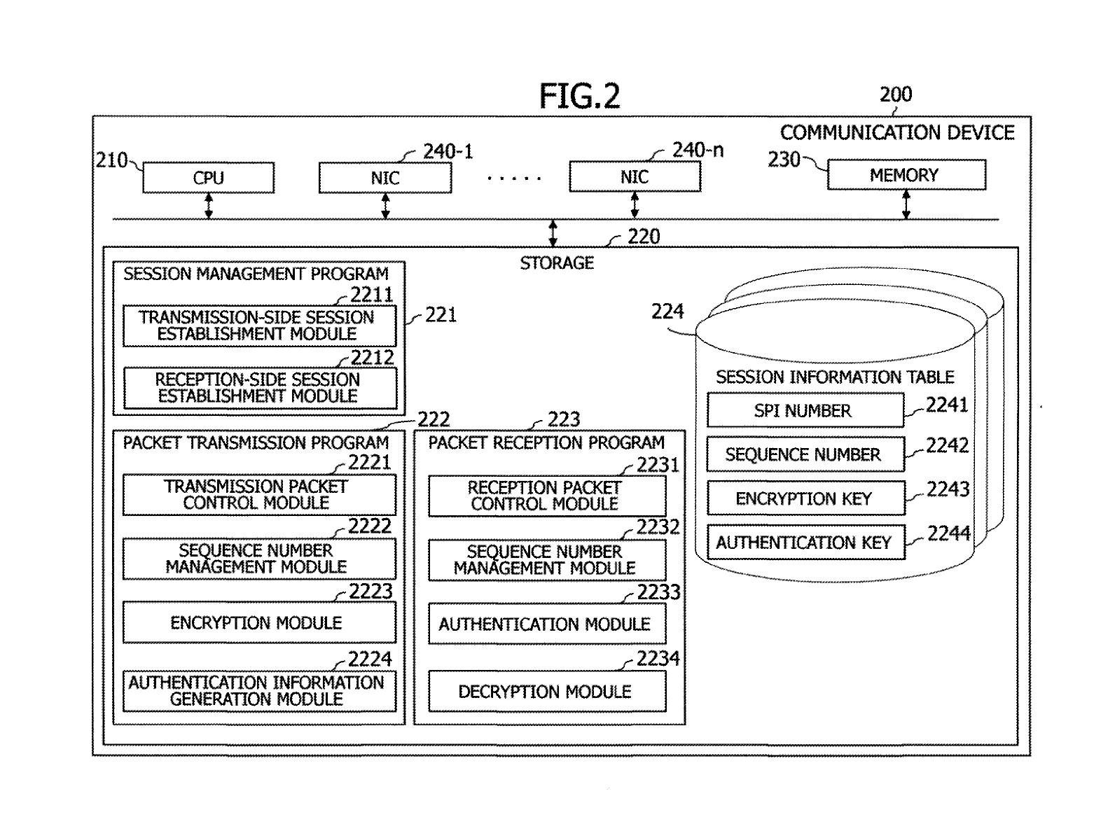

FIG. 2 is a view illustrating an example of the configuration of the communication device 200.

The communication device 200 has a central processing unit (CPU) 210, a storage 220, a memory 230, and network interface cards (NICs) 240-1 to 240-n.

The storage 220 is an auxiliary storage device that stores programs and data. The storage 220 stores a session management program 221, a packet transmission program 222, a packet reception program 223, and a session information table 224.

The session information table 224 is a table that stores information related to the session in the communication with the communication device serving as the packet transmission destination. Information elements to be stored include a security parameter index (SPI) number 2241, a sequence number 2242, an encryption key 2243, and an authentication key 2244. The SPI number is a numerical value that differs from one session to another, and is an identifier of the session. In addition, the SPI number is issued by the communication device 200 on the transmission side of the packet and, in the session of the SPI number, the packet can be transmitted only from the communication device 200 that has issued the SPI number. For example, in the case where the transmission and the reception of the packet are performed between two communication devices, the communication devices issue different SPI numbers and perform the communication with two sessions. The communication device 200 can have a plurality of the sessions at the same time in order to perform the transmission/reception of the packet and the communication with a plurality of the communication devices. In this case, the session information table 224 is provided for each SPI number. The session information table 224 is generated when the SPI number is acquired and, when the communication with the SPI number is ended and the session is released, the session information table 224 of the SPI number is erased. Further, the SPI number is used for the generation of the authentication information.

The memory 230 is a region into which the program stored in the storage 220 is loaded. In addition, the memory 230 is used as a region in which the program stores data.

The NICs 240-1 to 240-n are devices that are connected to other communication devices wirelessly or in a wired manner, and perform the communication. The NICs 240-1 to 240-n may also be connected to other communication devices via hubs or switches.

The CPU 210 is a processor that loads the program stored in the storage 220 into the memory 230, executes the loaded program, and implements individual processes.

The CPU 210 executes individual modules included in the session management program 221 to thereby manage the session with another communication device. The session management program 221 has a transmission-side session establishment module 2211 and a reception-side session establishment module 2212.

The transmission-side session establishment module 2211 executes a transmission-side session establishment process that establishes the session when the communication device starts the transmission of the packet to another communication device. In the transmission-side session establishment process, the communication device 200 adds the issued SPI number and candidates for the sequence number mode that can be adopted to a security association (SA) establishment request, and transmits the SA establishment request to the communication device serving as the transmission destination. Subsequently, the communication device 200 acquires the encryption key, the authentication key, and the sequence number mode adopted by the communication device serving as the transmission destination that are included in an SA establishment response to the SA establishment request, stores them in the session information table 224, and sets the sequence number 2242 to an initial value by updating.

The reception-side session establishment module 2212 executes a reception-side session establishment process that establishes the session when the communication device serving as the transmission source requests the establishment of the session. When the communication device 200 receives the SA establishment request in the reception-side session establishment process, the communication device 200 acquires the SPI number and the candidates for the sequence number mode that can be adopted that are included in the SA establishment request. Subsequently, the communication device 200 adds the sequence number mode determined from the candidates for the sequence number mode that can be adopted, and the encryption key, the authentication key and the like generated based on the SPI number to the SA establishment response, and transmits the SA establishment response to the communication device serving as the transmission source. In addition, the communication device 200 stores the SPI number, the encryption key, and the authentication key in the session information table 224, and sets the sequence number 2242 to an initial value by updating.

In addition, the CPU 210 executes individual modules included in the packet transmission program 222 to thereby construct a packet transmission unit and execute a packet transmission process. The packet transmission program 222 has a transmission packet control module 2221, a sequence number management module 2222, an encryption module 2223, and an authentication information generation module 2224.

The transmission packet control module 2221 executes a transmission packet control process that performs the generation and transmission of the packet. In the transmission packet control process, the communication device 200 executes the sequence number management module 2222 to increment the sequence number 2242. In addition, the communication device 200 executes the encryption module 2223 to encrypt data serving as an encryption target. Further, the communication device 200 executes the authentication information generation module 2224 to acquire the generated authentication information. Subsequently, the communication device 200 transmits the packet to which the sequence number, the encrypted data, the authentication information and the like are added to the communication device serving as the transmission destination.

The sequence number management module 2222 executes a sequence number management process (transmission side). In the sequence number management process (transmission side), the communication device 200 increments the sequence number, and performs monitoring such that the sequence number is not overflowed. In the case where the sequence number is overflowed, the communication device 200, e.g., releases the SPI number with which the session is established, and establishes the new session with the reacquired SPI number.

The encryption module 2223 executes an encryption process of data serving as the encryption target. In the encryption process, the communication device 200 encrypts the data serving as the encryption target based on the encryption key 2243.

The authentication information generation module 2224 executes an authentication information generation process that generates the authentication information to be added to the transmission packet. In the authentication information generation process, the communication device 200 generates the authentication information based on the sequence number, the encrypted data, the SPI number and the like.

Further, the CPU 210 executes individual modules included in the packet reception program 223 to thereby construct a packet reception unit and execute a packet reception process. The packet reception program 223 has a reception packet control module 2231, a sequence number management module 2232, an authentication module 2233, and a decryption module 2234.

The reception packet control module 2231 executes a reception packet control process that performs the authentication and decryption of the received packet. In the received packet control process, the communication device 200 executes the sequence number management module 2232 to determine whether or not the sequence number of the received packet is invalid. The invalid sequence number is the sequence number that is deviated from the previously received sequence number by a predetermined value or more. In the case where the sequence number is not invalid, the communication device 200 executes the authentication module 2233 to authenticate the received packet. Subsequently, in the case where the authentication result is OK, the communication device 200 sets the sequence number 2242 to the sequence number included in the received packet by updating, executes the decryption module 2234, and decrypts the encrypted data.

The sequence number management module 2232 executes a sequence number management process (reception side). In the sequence number management process (reception side), the communication device 200 determines whether or not the sequence number of the received packet is invalid, and updates the sequence number 2242 when the sequence number is not invalid.

The authentication module 2233 executes an authentication process of the received packet. In the authentication process, the communication device 200 generates the authentication information from the authentication key 2244, and the sequence number, the SPI number, and the encrypted data, which are included in the received packet, determines whether or not the generated authentication information matches the authentication information included in the received packet, and determines that the authentication is OK when the generated authentication information matches the authentication information included in the received packet.

The decryption module 2234 executes a decryption process of the encrypted data of the received packet. In the decryption process, the communication device 200 decrypts the encrypted data of the received packet based on the encryption key 2243.

<Packet Transmission/Reception Process>

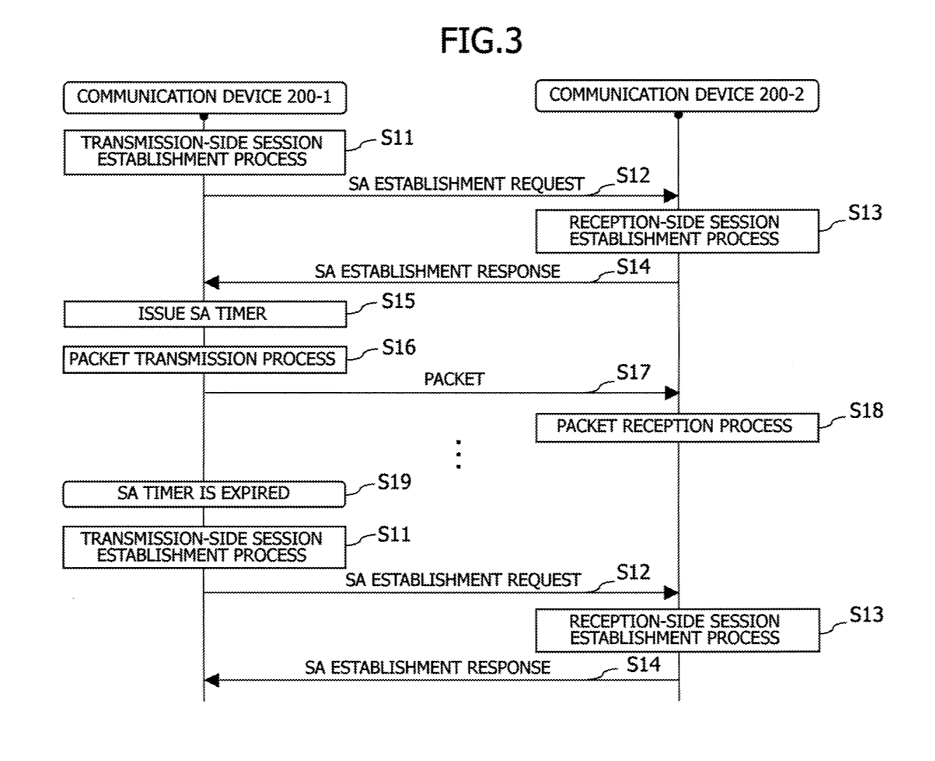

FIG. 3 is a view illustrating an example of the sequence of the packet transmission and reception in the communication device. Hereinbelow, by using FIG. 3, the case where the packet is transmitted from a communication device 200-1 to a communication device 200-2 will be described.

When the communication device 200-1 starts the transmission of the packet to the communication device 200-2, the communication device 200-1 executes the transmission-side session establishment process (S11). Subsequently, the communication device 200-2 as the transmission destination of the packet receives the SA establishment request, and executes the reception-side session establishment process (S13).

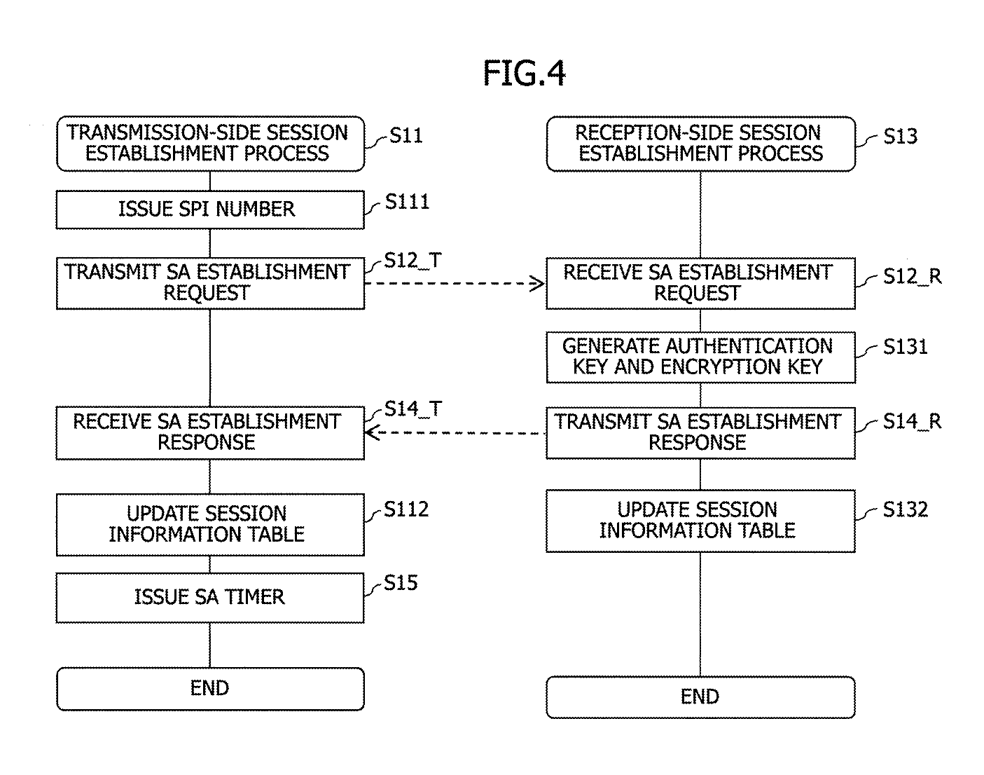

FIG. 4 is a view illustrating an example of a process flowchart of each of the transmission-side session establishment process (S11) and the reception-side session establishment process (S13). In the transmission-side session establishment process (S11), the communication device 200-1 issues the SPI number (S111). In the first embodiment, the first extension mode is adopted as the sequence number mode. Accordingly, the SPI number region is a 32-bit region, but the bit string of the sequence number is stored in the lower 8 bits, and hence the SPI number has 24 bits. The communication device 200-1 transmits the SA establishment request to which the SPI number and information indicating that the sequence number mode to be adopted is the first extension mode are added to the communication device 200-2 (S12).

In the reception-side session establishment process (S13), when the communication device 200-2 receives the SA establishment request (S12), the communication device 200-2 generates the authentication key and the encryption key based on the SPI number included in the received SA establishment request (S131). The communication device 200-2 transmits the SA establishment response to which the generated authentication key and encryption key and the adopted sequence number mode (the first extension mode in this case) are added to the communication device 200-1 (S14). Subsequently, the communication device 200-2 updates the session information table 224 (S132). The communication device 200-2 sets the SPI number 2241 to the SPI number received via the SA establishment request by updating, sets the values of the encryption key 2243 and the authentication key 2244 to the values of the generated encryption key and authentication key by updating, and sets the sequence number to the initial value by updating.

When the communication device 200-1 receives the SA establishment response (S14), the communication device 200-1 updates the session information table (S112). The communication device 200-2 sets the SPI number 2241 to the SPI number transmitted by the SA establishment request by updating, sets the values of the encryption key 2243 and the authentication key 2244 to the values of the encryption key and the authentication key included in the SA establishment response by updating, and sets the sequence number to the initial value by updating. Subsequently, the communication device 200-2 issues an SA timer (S15). The SA timer is a timer for preventing the sequence number from reaching the upper limit value. The timer value of the SA timer is set to the amount of time slightly smaller than the amount of time until the sequence number reaches the upper limit value in the case where, e.g., the packet is successively transmitted at the maximum communication speed between the communication devices. When the SA timer is expired, the communication device 200-1 reissues the SPI number and establishes the new session.

Returning to the sequence in FIG. 3, the communication device 200-1 issues the SA timer (S15), and executes the packet transmission process (S16).

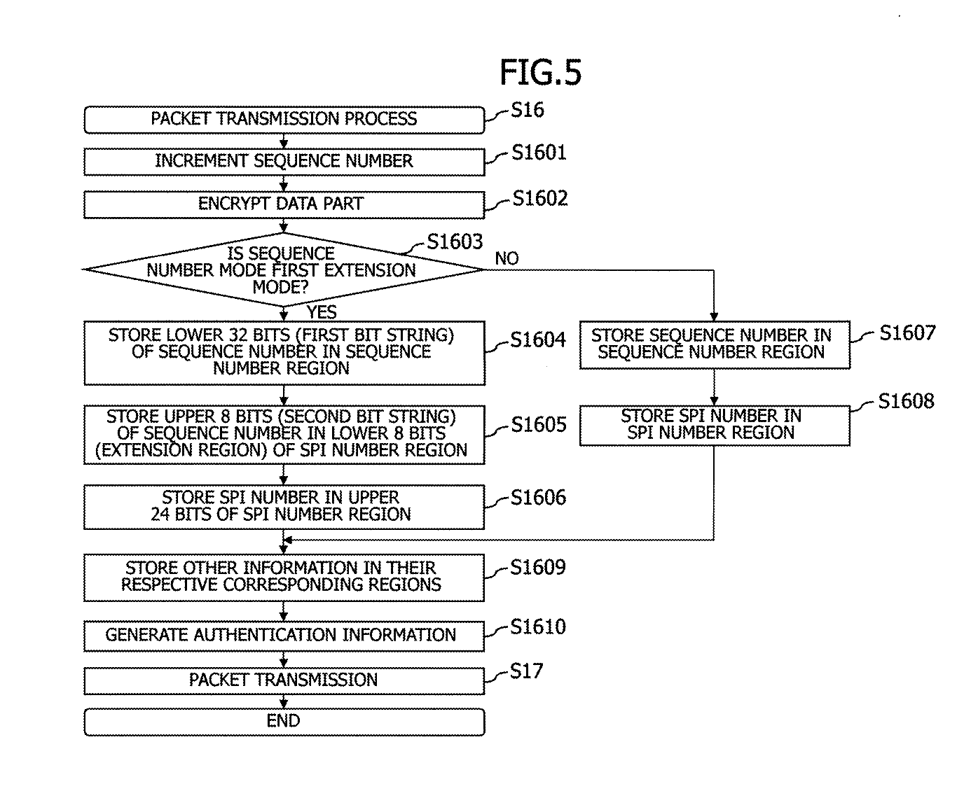

FIG. 5 is a view illustrating an example of a process flowchart of the packet transmission process (S16). In the packet transmission process (S16), the communication device 200-1 increments the sequence number 2242 (S1601). This is because, at the time of start of the packet transmission process, the sequence number 2242 is set to the initial value or the number at the time of the previous packet transmission. Subsequently, the communication device 200-1 determines whether or not the sequence number mode is the first extension mode (S1603). In the first embodiment, the sequence number mode is the first extension mode (Yes in S1603). In the packet transmission process (S16), the storage regions of the sequence number and the SPI number differ depending on the sequence number mode.

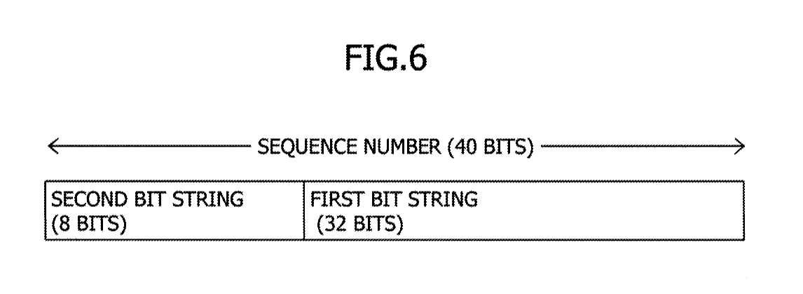

FIG. 6 is a view illustrating an example of the sequence number in the first extension mode. In the first extension mode, the sequence number has 40 bits. The lower 32 bits are referred to as a first bit string, and correspond to, e.g., the sequence number in the 32-bit mode. The upper 8 bits are referred to as a second bit string, and is a bit string extended from the sequence number in the 32-bit mode.

Returning to the process flowchart in FIG. 5, the communication device 200-1 stores the first bit string in the sequence number region (S1604). The communication device 200-1 stores the second bit string in the lower 8 bits (extension region) of the SPI number region (S1605). Subsequently, the communication device 200-1 stores the SPI number in the upper 24 bits of the SPI number region (S1606).

In the case where the sequence number mode is not the first extension mode (No in S1603), e.g., in the case where the sequence number mode is the 32-bit mode, the sequence number and the SPI number are stored in their respective corresponding regions (S1607 and S1608).

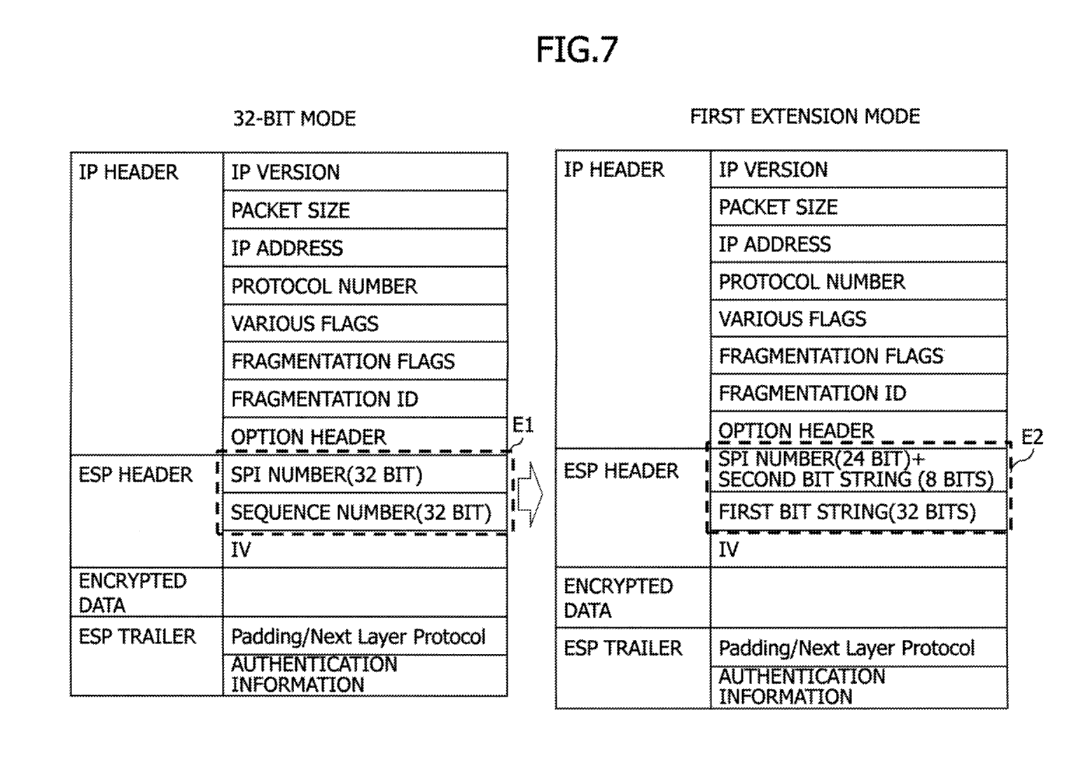

FIG. 7 is a view illustrating examples of information elements stored in the packet in the 32-bit mode and the first extension mode. The packet in each of the 32-bit mode and the first extension mode has an Internet protocol (IP) header, an encapsulating security payload (ESP) header, encrypted data, and an ESP trailer as the information elements. Fragmentation flags are information items on a flag indicating whether or not fragmentation is performed and offset of the fragmentation in the case where the fragmentation is performed. In the 32-bit mode, the SPI number (32 bits) is stored in the SPI number region of the ESP header, and the sequence number (32 bits) is stored in the sequence number region (E1). On the other hand, in the first extension mode, the SPI number (24 bits) is stored in the upper 24 bits of the SPI number region of the ESP header, the second bit string (8 bits) is stored in the lower 8 bits thereof, and the first bit string (32 bits) is stored in the sequence number region.

Thus, by storing the second bit string of the sequence number extended by the first extension mode in part of the region in which the SPI number is conventionally stored, it is possible to transmit all of the 40 bits of the sequence number to the communication device serving as the transmission destination without changing the conventional packet size.

Note that the SPI number is the identifier of the session and, when the number of the SPI numbers allows the execution of simultaneous communication, the SPI number does not become insufficient. That is, when the SPI number has 24 bits, it becomes possible to establish sessions the number of which is 2 to the power of 24 at the same time, and the SPI number does not become insufficient in the communication system in which the number of communication devices is limited.

Returning to the process flowchart in FIG. 5, the communication device 200-1 stores information other than the sequence number and the SPI number in their respective corresponding regions (S1609). Further, the communication device 200-1 generates the authentication information based on information included in the ESP header, the encrypted data, and the ESP trailer (S1610), and transmits the packet to which the generated authentication information is added (S17).

Returning to the sequence in FIG. 3, the communication device 200-2 having received the packet executes the packet reception process (S18).

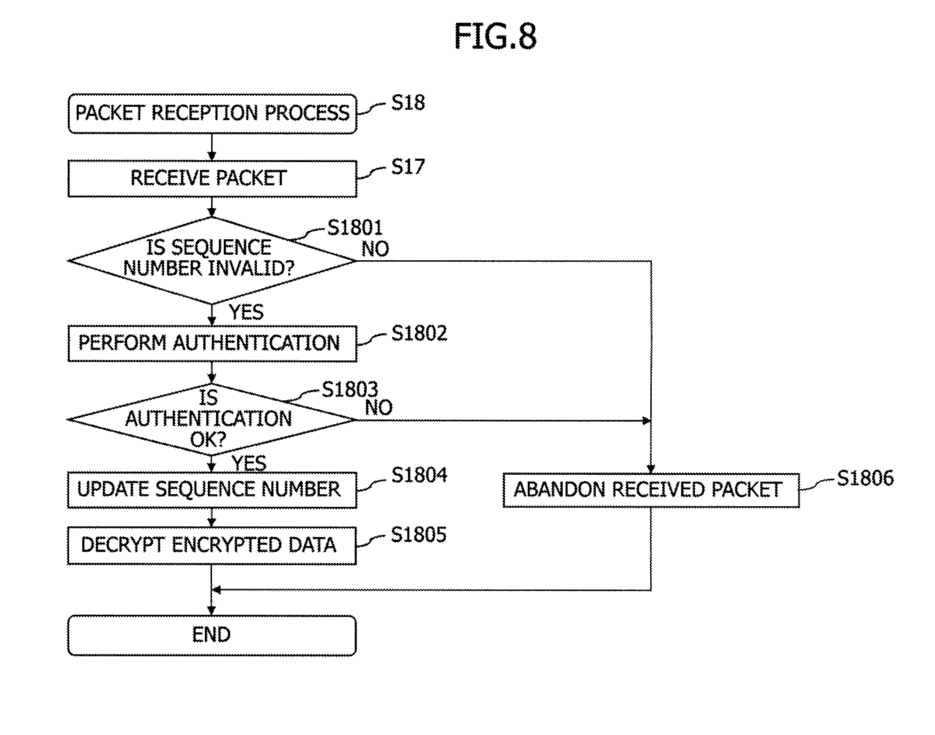

FIG. 8 is a view illustrating an example of a process flowchart of the packet reception process (S18). In the packet reception process (S18), when the communication device 200-2 receives the packet (S17), the communication device 200-2 determines whether or not the sequence number of the packet is invalid (S1801). In the determination of the invalid sequence number, for example, when the sequence number of the received packet has the same numerical value as that of the previously received sequence number or smaller than that of the previously received sequence number, it is determined that the sequence number is invalid. Alternatively, when the sequence number of the received packet is smaller than the previously received sequence number by a predetermined numerical value or more, it may be determined that the sequence number is invalid.

In the case where the sequence number of the received packet is not invalid (Yes in S1801), the communication device 200-2 performs the authentication (S1802). In the authentication, the authentication information is generated based on the information included in the ESP header, the encrypted data, and the EPS trailer of the received packet, and it is determined whether or not the generated authentication information matches the authentication information added to the received packet. In the case where the authentication is OK (Yes in S1804), the sequence number 2242 is updated and set to the sequence number of the received packet (S1804). Subsequently, the encrypted data of the received packet is decrypted based on the encryption key 2243 (S1805).

In the case where the sequence number of the received packet is invalid (No in S1801) and the authentication is NG (No in S1803), the received packet is abandoned (S1806).

Returning to the sequence in FIG. 3, the communication device 200-1 repeats the packet transmission process until the transmission of the data is completed. Similarly, the communication device 200-2 repeats the packet reception process.

When the SA timer is expired (S19), the communication device 200-1 releases the session of the SPI number, and ends the communication. Subsequently, the SPI number is newly issued, and the transmission-side session establishment process and the reception-side session establishment process are performed. Note that, in the case where the data transmission is completed before the SA timer is expired, the communication device 200-1 stops the SA timer, releases the session of the SPI number, and ends the process.

In the first embodiment, the communication is performed by using the sequence number extended by bits corresponding to the second bit string (8 bits), and hence the amount of time until the sequence number reaches the upper limit value is increased, and the timer value of the SA timer is also increased. Accordingly, the time interval between the reacquisition of the SPI number and the reestablishment of the session is increased, and it is possible to reduce the frequency of occurrence of the time period in which it is not possible to perform the communication. In addition, the extended sequence number is stored in the packet by using the extension region and transmits the packet to the communication device serving as the transmission destination, and hence the mismatch of the sequence number between the communication devices as the transmission destination and the transmission source does not occur. Accordingly, even when a failure occurs in the connection between the communication devices and it is not possible to perform the packet communication for a specific time period, a phenomenon in which the received packet is successively abandoned, which is likely to occur in the conventional 64-bit mode, does not occur. Therefore, the time period in which it is not possible to perform the communication as the entire communication system is short, and it is possible to provide a more comfortable communication environment to a user who uses the communication system.

In addition, in a second embodiment described later, it is determined whether or not the fragmentation is performed according to the amount of data to be transmitted and the packet size and, in the case where the fragmentation is performed, it is not possible to store the extended sequence number in the packet. However, the SPI number is the numerical value that is not related to the transmission data amount or the packet size, and hence it is possible to use the first extension mode irrespective of the transmission data amount and the packet size.

### Second Embodiment

Next, the second embodiment will be described.

In the second embodiment, the sequence number indicative of the order of transmission of the packet is extended by 16 bits from 32 bits in the 32-bit mode to 48 bits. In the first embodiment, part of the SPI number region is used as the extension region. On the other hand, in the second embodiment, in the case where a fragmentation identification (ID) is not stored in a region corresponding to the fragmentation ID (hereinafter referred to as a fragmentation ID region), the fragmentation ID region is used as the extension region.

Note that the sequence number mode in which the sequence number is extended and the bit string obtained by the extension is stored in the fragmentation ID region in the second embodiment is referred to as a second extension mode.

<Fragmentation Process>

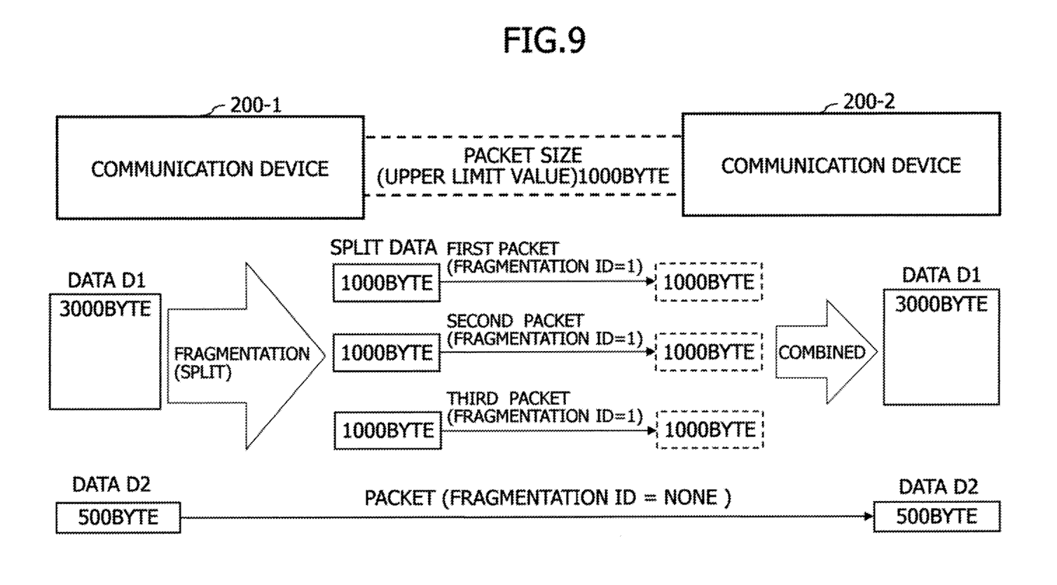

FIG. 9 is a view illustrating the case where the fragmentation is performed and the case where the fragmentation is not performed in the packet transmission between the communication devices. Hereinbelow, the case where the packet is transmitted from the communication device 200-1 to the communication device 200-2 will be described by using FIG. 9. Note that, in the communication width of the communication devices 200-1 and 200-2, the upper limit value of the packet size is 1000 bytes.

The case where the communication device 200-1 transmits data D1 of 3000 bytes will be described. The data D1 exceeds the upper limit value of the packet size, and hence it is not possible for the communication device 200-1 to transmit the data of 3000 bytes in one packet. Accordingly, the data of 3000 bytes needs to be divided and transmitted. The process that divides and transmits the packet is referred to as fragmentation (or divided transmission). The communication device 200-1 divides the data D1 into three pieces of data each having 1000 bytes, adds the same fragmentation ID (1 in FIG. 9) to each of the three pieces of the divided data obtained by the dividing, and transmits the three pieces of the divided data to the communication device 200-2. The fragmentation ID is the identifier added in the case where the fragmentation is performed and, as the fragmentation ID, the same numerical value is added to pieces of data when the pieces of data are obtained by dividing the same data. Subsequently, the communication device 200-2 combines the pieces of the divided data having the same fragmentation ID to construct the data D1.

Next, the case where the communication device 200-1 transmits data D2 of 500 bytes will be described. The data D2 is data of 500 bytes that does not exceeds the packet size, and hence the communication device 200-1 can transmit the data D2 in one packet. Therefore, the communication device 200-1 transmits the data without performing the fragmentation. The process that transmits the packet without dividing the packet is referred to as non-fragmentation (non-divided transmission). In the case of the non-fragmentation, the fragmentation ID is not used.

Thus, in the case where the size of the data to be transmitted does not exceed the packet size, the non-fragmentation is performed, and hence it is possible to use the fragmentation ID region as the extension region to which the sequence number is added.

<Packet Transmission/Reception Process>

The sequence of the packet transmission/reception is the same as the sequence in FIG. 3. The packet transmission process (S16) in the first embodiment is partially different from that in the second embodiment, and hence the packet transmission process will be described.

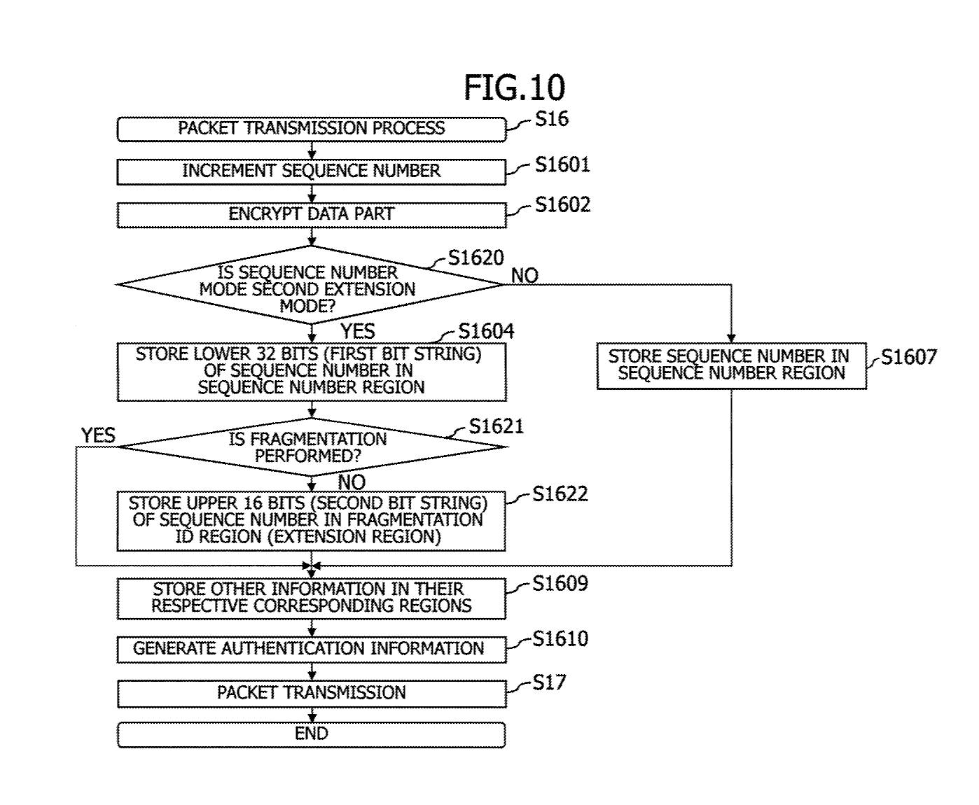

FIG. 10 is a view illustrating an example of a process flowchart of the packet transmission process in the second extension mode. The processes in which the sequence number is incremented (S1601) and the data is encrypted (S1602) are the same as those in the first embodiment.

The communication device 200-1 determines whether or not the sequence number mode is the second extension mode (S1620). This is because the region in which the sequence number is stored in the second extension mode is different from those in the other modes.

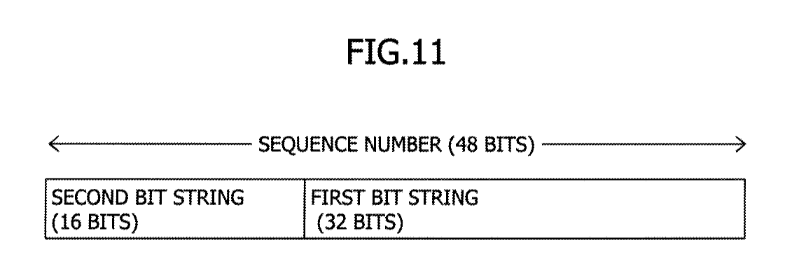

FIG. 11 is a view illustrating an example of the sequence number in the second extension mode. In the second extension mode, the sequence number has 48 bits. The lower 32 bits are referred to as the first bit string, and the upper 16 bits are referred to as the second bit string.

Returning to the process flowchart in FIG. 10, in the case where the sequence number mode is the second extension mode (Yes in S1620), the communication device 200-1 stores the first bit string in the sequence number region (S1604). Subsequently, the communication device 200-1 determines whether or not the fragmentation is performed on the packet to be transmitted (S1621).

In the case where the fragmentation is not performed (No in S1621), the communication device 200-1 stores the second bit string in the fragmentation ID region (S1622). In addition, the communication device 200-1 stores the other information in their respective corresponding regions (S1609). Note that, in the case where the fragmentation is performed (Yes in S1621), the communication device 200-1 stores the fragmentation ID in the fragmentation ID region in the information storage process (S1609).

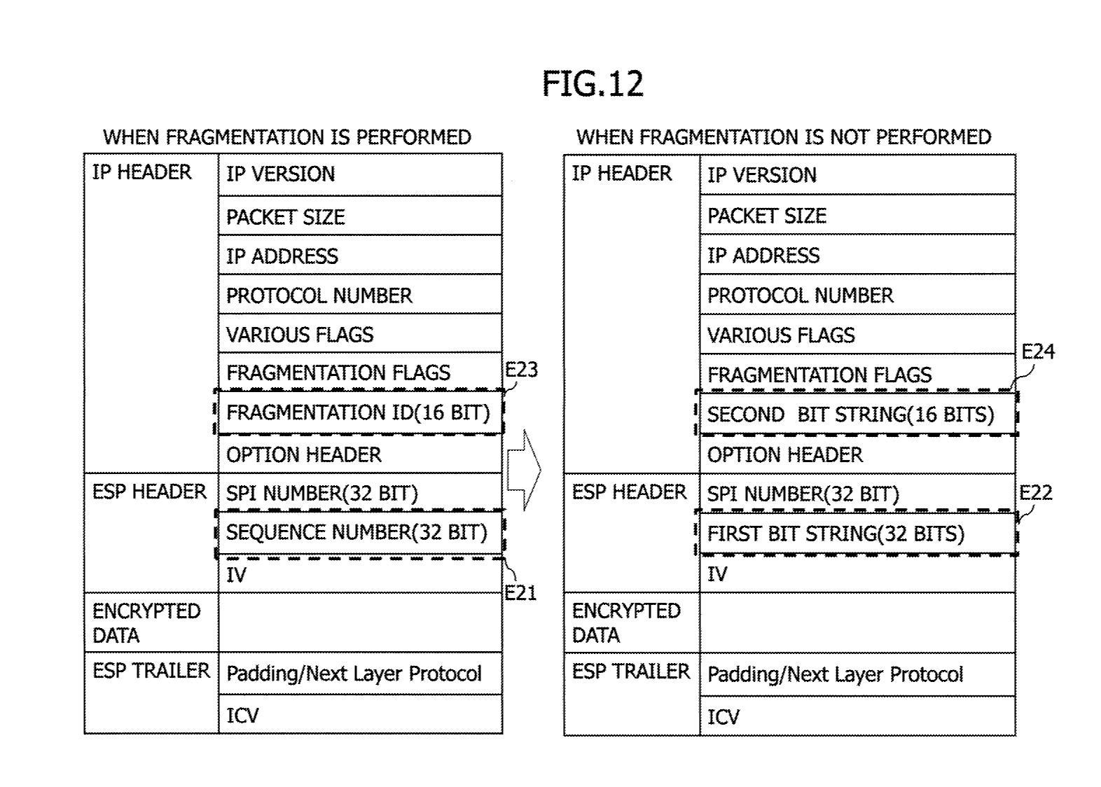

FIG. 12 is a view illustrating examples of the information elements stored in the packet in the case where the fragmentation is performed and the case where the fragmentation is not performed in the second extension mode. In the case where the fragmentation is performed, the sequence number (32 bits) is stored in the sequence number region (E21). On the other hand, in the case where the fragmentation is not performed, the first bit string (32 bits) is stored in the sequence number region of the ESP header (E22).

In the case where the fragmentation is performed, the fragmentation ID (16 bits) is stored in the fragmentation ID region (E23). On the other hand, in the case where the fragmentation is not performed, the second bit string is stored in the fragmentation ID region (E24).

Thus, in the case where the fragmentation is not performed, the second bit string of the sequence number extended by the second extension mode is stored in the region in which the fragmentation ID is conventionally stored. With this, it is possible to transmit all of the 48 bits of the sequence number to the communication device serving as the transmission destination without changing the conventional packet size.

Returning to the process flowchart in FIG. 10, similarly to the first embodiment, the communication device 200-1 generates the authentication information (S1610), and transmits the packet to which the generated information is added (S17).

In the second embodiment, the communication is performed by using the sequence number extended by bits corresponding to the second bit string, and hence it is possible to reduce the frequency of occurrence of the time period in which it is not possible to perform the communication. In addition, the extended sequence number is stored in the packet by using the extension region and is transmitted to the communication device serving as the transmission destination, and hence successive abandonment of the packet resulting from the mismatch of the sequence number does not occur. Therefore, the time period in which it is not possible to perform the communication as the entire communication system is short, and it is possible to provide the more comfortable communication environment to the user who uses the communication system.

In the first embodiment described above, there are cases where the SPI number becomes insufficient depending on the number of sessions that are established at the same time in the entire communication system. However, in the second embodiment, the fragmentation ID region is used, and hence it is possible to use the second extension mode without depending on the number of sessions that are established at the same time in the entire communication system.

Note that, in the generation of the authentication information in the second embodiment, other than the information included in the ESP header, the encrypted data, and the ESP trailer used as the base at the time of the generation of the authentication information in the first embodiment, the fragmentation ID (the second bit string) may be added. With this, data used as the base for the generation of the authentication information is increased, and security is improved.

### Third Embodiment

Next, a third embodiment will be described.

In the third embodiment, the communication to which a third extension mode that uses an extended sequence number obtained by further adding the extension bit string to the sequence number in the first extension mode is applied is performed. In the third extension mode, the extension bit string is not stored in the packet but is internally managed by the communication devices as the transmission source and the transmission destination.

<Example of Configuration of Communication Device>

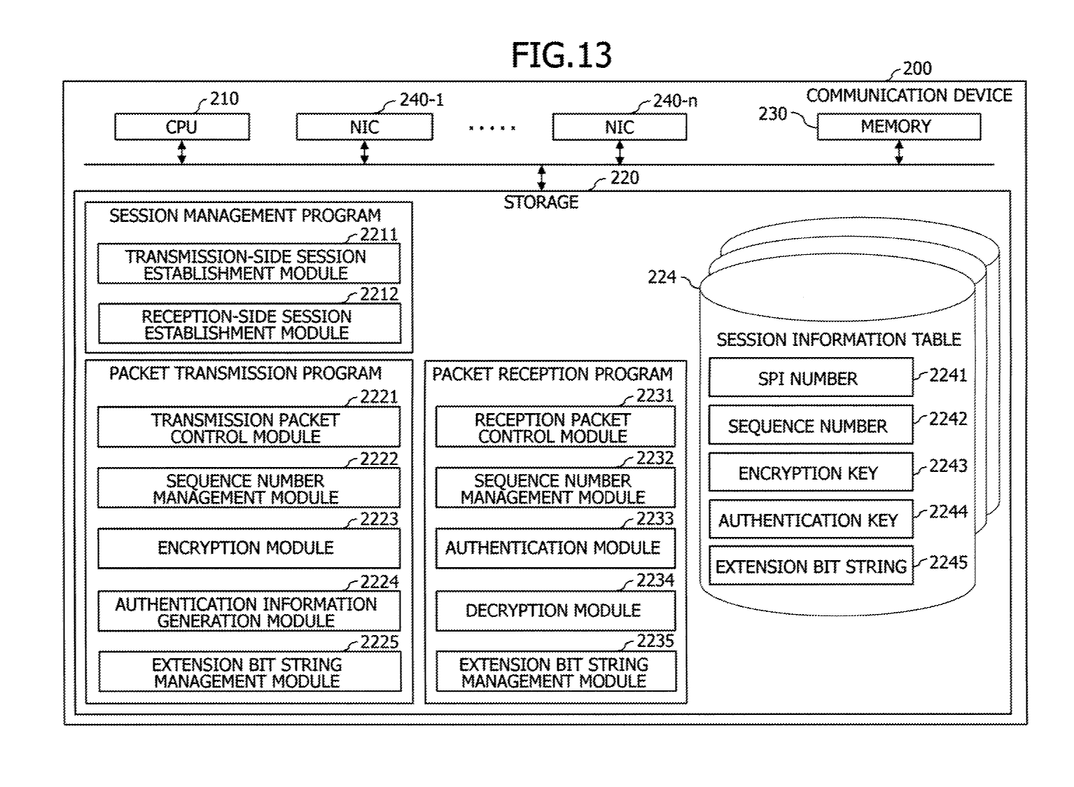

FIG. 13 is a view illustrating an example of the configuration of the communication device 200.

In addition to the configuration illustrated in FIG. 2, the communication device 200 has an extension bit string management module 2225 in the packet transmission program 222, an extension bit string management module 2235 in the packet reception program 223, and an extension bit string 2245 in the session information table 224.

The CPU 210 executes the extension bit string management module 2225 included in the packet transmission program 222 to thereby construct an extended sequence number management unit and execute a transmission-side extension bit string management process. The transmission-side extension bit string management process is a process for incrementing the extension bit string 2245 when the sequence number is overflowed in the sequence number management process. In addition, in the transmission-side extension bit string management process, in the case where the extension bit string 2245 is overflowed, the session is released and the SPI number is cleared.

In addition, the CPU 210 executes the extension bit string management module 2235 included in the packet reception program 223 to thereby construct the extended sequence number management unit and execute a reception-side extension bit string management process. The reception-side extension bit string management process is a process for incrementing the extension bit string 2245 when the sequence number is overflowed in the sequence number management process. In addition, in the reception-side extension bit string management process, in the case where the extension bit string 2245 is overflowed, a process in which all of the subsequent packets having the same SPI number are abandoned is executed.

<Packet Transmission/Reception Process>

The sequence of the packet transmission/reception is the same as the sequence in FIG. 3. The packet transmission process (S16) and the packet reception process (S18) in the first embodiment are partially different from those in the third embodiment, and hence the processes will be described.

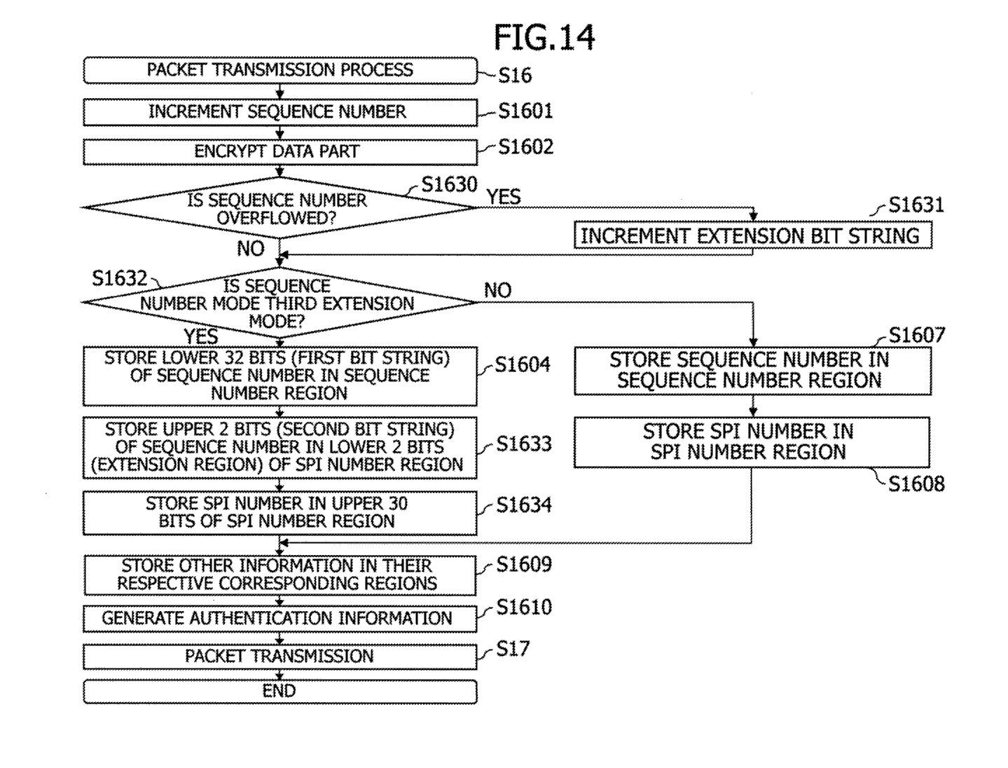

FIG. 14 is a view illustrating an example of a process flowchart of the packet transmission process in the third extension mode. The processes in which the sequence number is incremented (S1601) and the data is encrypted (S1602) are the same as those in the first embodiment.

The communication device 200-1 determines whether or not the sequence number is overflowed (S1630). In the case where the sequence number is overflowed (Yes in S1630), the communication device 200-1 increments the extension bit string 2245 (S1631).

The communication device 200-1 confirms the sequence number mode (S1632). In the packet transmission process (S16), the storage regions of the sequence number and the SPI number differ depending on the sequence number mode.

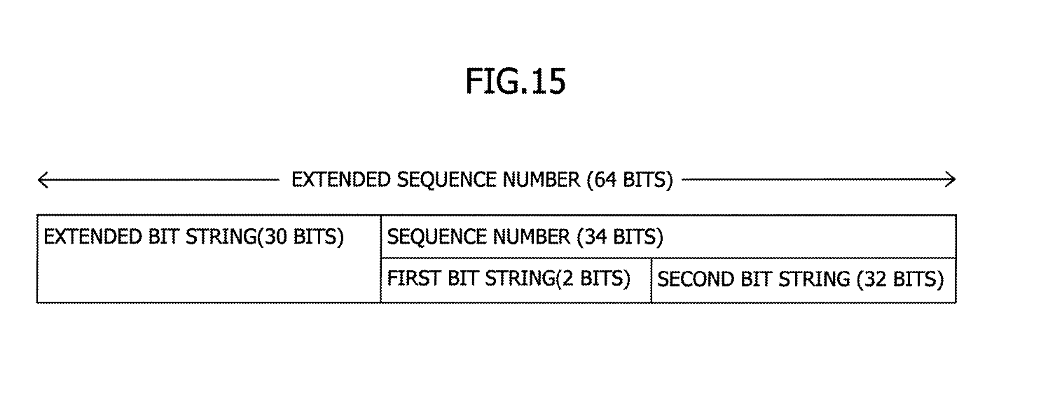

FIG. 15 is a view illustrating an example of the extended sequence number in the third extension mode. In the third extension mode, the extended sequence number has 64 bits. The upper 30 bits of the extended sequence number is the bit string that is not stored in the packet, and is referred to as the extension bit string. The lower 34 bits are used as the sequence number, the sequence number is stored in the packet, and the packet is transmitted to the communication device serving as the transmission destination. The lower 32 bits of the sequence number are referred to as the first bit string, and the upper 2 bits thereof are referred to as the second bit string.

Returning to the process flowchart in FIG. 14, in the case where the sequence number mode is the third extension mode (Yes in S1632), the communication device 200-1 stores the first bit string in the sequence number region (S1604). The communication device 200-1 stores the second bit string in the lower 2 bits (extension region) of the SPI number region (S1633). Subsequently, the communication device 200-1 stores the SPI number in the upper 30 bits of the SPI number region (S1634).

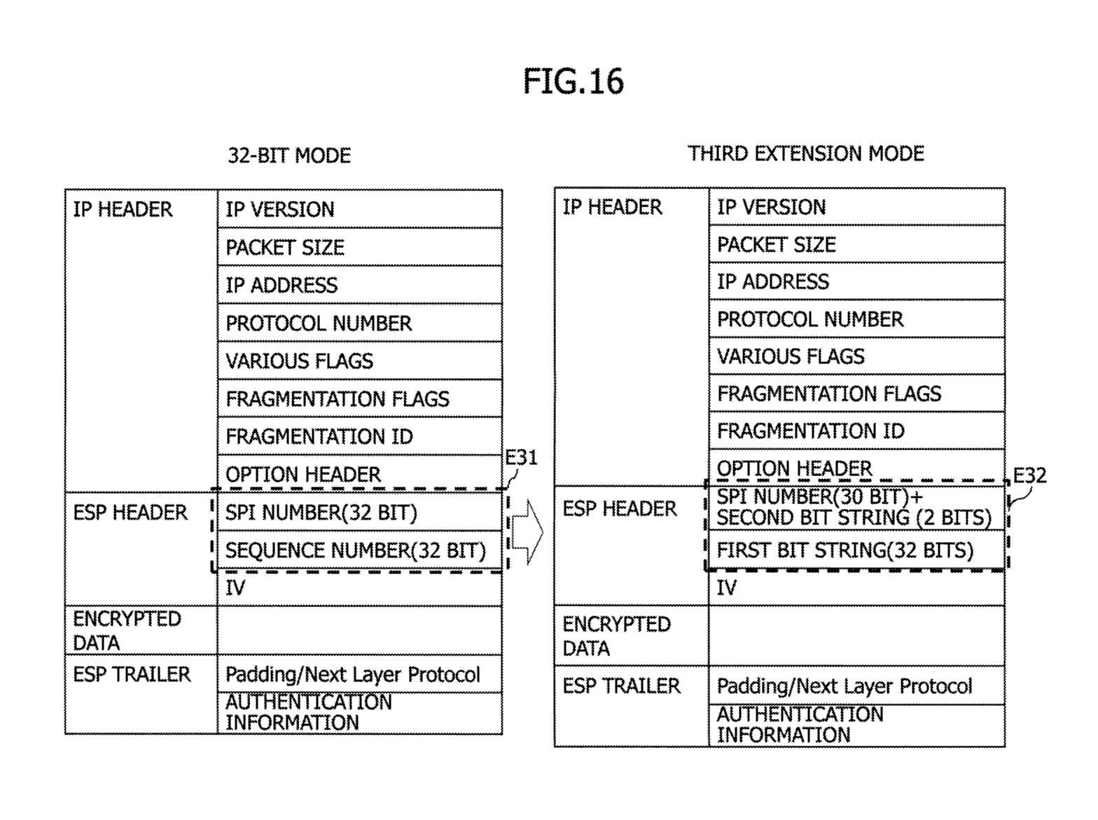

FIG. 16 is a view illustrating examples of the information elements stored in the packet in the 32-bit mode (or the 64-bit mode) and the third extension mode. The 32-bit mode and the 64-bit mode have the same configuration of the information elements in the packet. In the 32-bit mode, the SPI number (32 bits) is stored in the SPI number region of the ESP header, and the sequence number (32 bits) is stored in the sequence number region (E31). On the other hand, in the third extension mode, the SPI number (30 bits) is stored in the upper 30 bits of the SPI number region of the ESP header, the second bit string (2 bits) is stored in the lower 2 bits thereof, and the first bit string (32 bits) is stored in the sequence number region.

Thus, the second bit string of the sequence number extended by the first extension mode is stored in part of the region in which the SPI number is conventionally stored, whereby it is possible to transmit the 34 bits of the sequence number to the communication device serving as the transmission destination without changing the conventional packet size.

Returning to the process flowchart in FIG. 14, processes in the case where the sequence number mode is not the third extension mode (No in S1633) are the same as the processes (S1607 and S1608) in the first embodiment.

The communication device 200-1 stores the information other than the sequence number and the SPI number in their respective corresponding regions (S1609). Further, the communication device 200-1 generates the authentication information based on the information included in the ESP header, the encrypted data, and the ESP trailer and the extension bit string (S1610), and transmits the packet to which the generated authentication information is added (S17).

The communication device 200-2 receives the packet (S17), and performs the packet reception process (S18).

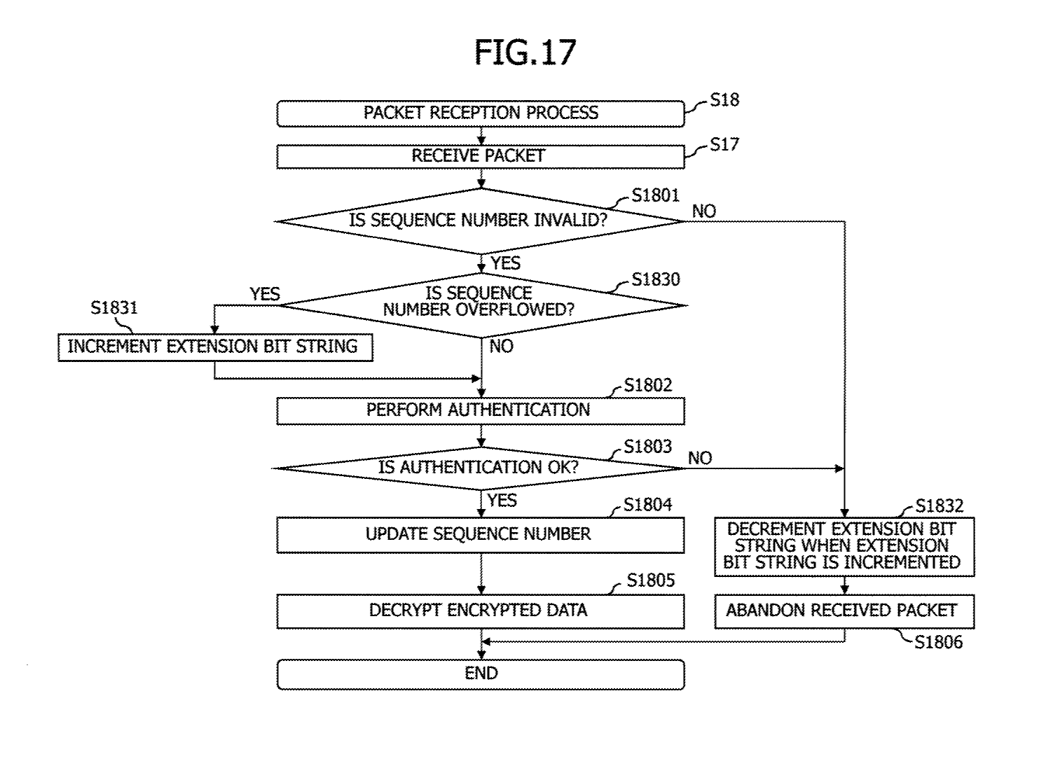

FIG. 17 is a view illustrating an example of a process flowchart of the packet reception process (S18). In the case where the sequence number is not invalid (Yes in S1801), the communication device 200-2 determines whether or not the sequence number is overflowed (S1830). In the determination of whether or not the sequence number is overflowed, for example, in the case where the sequence number of the currently received packet is smaller than the previously received sequence number, it is determined that the sequence number is overflowed. In the case where the sequence number is overflowed (Yes in S1830), the extension bit string 2245 is incremented (S1831).

The communication device 200-1 generates the authentication information based on the information included in the ESP header, the encrypted data, and the ESP trailer of the received packet, and the extension bit string 2245, and performs the authentication by determining whether or not the generated authentication information matches the authentication information added to the received packed (S1802).

In the case where the authentication is not OK (No in S1803), the packet is abandoned (S1806), and hence, in the case where the extension bit string is incremented, the extension bit string is decremented (S1832) for setting the numerical value of the extension bit string back to the original numerical value of the extension bit string.

In the third embodiment, as in the conventional 64-bit mode, part of the extended sequence number is not transmitted to the packet but is internally managed by the communication device. However, in addition to the sequence number having 32 bits store in the packet in the conventional 64-bit mode, the bit string of 2 bits is further stored in the extension region of the packet. For example, when high-speed communication is performed at a speed that exceeds 100 gigabits per second (Gbps), in the case where a time period of about 30 seconds or more in which the packet does not reach has occurred, the extended sequence number is incremented at the communication source, but it is not possible to increment the extended sequence number at the communication destination so that the mismatch occurs. However, by additionally storing 2 bits in the packet and transmitting the packet, even when a time period of not more than about 120 seconds that is 4 times 30 seconds in which the packet does not reach has occurred, the mismatch of the extended sequence number between the communication devices does not occur. By further increasing the bit string stored in the packet, it is possible to cope with a longer time period in which the packet does not reach.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device comprising:
a packet transmission unit that generates and transmits a packet including
a first bit string, which is a first part of a bit string of a sequence number indicating an order of transmission of the packet, in a sequence number region in the packet corresponding to sequence number information,
a second bit string, which is a second part other than the first part of the bit string of the sequence number, in an extension region other than the sequence number region, and
authentication information, which is generated based on the sequence number, in an authentication information region corresponding to the authentication information;
a packet reception unit that receives the packet including the sequence number and the authentication information from another communication device, and authenticates the received packet based on the sequence number and the authentication information included in the received packet.

2. The communication device according to claim 1, wherein
the first bit string includes lower bits of the bit string of the sequence number.

3. The communication device according to claim 1, wherein
a packet has a first region for including first information,
the packet transmission unit includes the first information in the extension region included in the first region, and includes the second bit string in a region other than the extension region included in the first region.

4. The communication device according to claim 3, wherein
the first information is an identifier of a session in communication in which the packet is transmitted and received.

5. The communication device according to claim 1, wherein
a packet has a second region for including second information,
the packet transmission unit includes the second information in the second region when including the second information in the packet, and includes the second bit string in the second region when not including the second information in the packet.

6. The communication device according to claim 5, wherein
the packet transmission unit performs divided transmission in which the packet is divided and the divided packet are transmitted or non-divided transmission in which the packet is transmitted without being divided,
the second information indicates an identifier of the packet before being divided in the divided transmission,
the packet transmission unit includes the second bit string in of the second region when performing the non-divided transmission, and
the packet transmission unit includes the second information in the second region when performing the divided transmission.

7. The communication device according to claim 1, further comprising:
an extended sequence number management unit that memorizes an extension bit string of an extended sequence number in which the extension bit string is added to the sequence number as upper bits, wherein
the packet transmission unit increments the sequence number, increments the extension bit string in accordance with the incremented sequence number, and generates the authentication information based on the extended sequence number when generating the packet, and
the packet reception unit increments the extension bit string in accordance with the sequence number included in the received packet, and performs the authentication based on the extended sequence number and the authentication information.

8. The communication device according to claim 1, wherein
the packet transmission unit encrypts encryption target data of the packet to be transmitted, and
the packet reception unit decrypts the encrypted encryption target data of the received packet.

9. A communication system comprising:
a first communication device that generates a packet including a first bit string, which is part of a bit string of a sequence number indicating an order of transmission of the packet, in a sequence number region in the packet corresponding to sequence number information,
a second bit string, which has bits other than the first bit string of the bit string of the sequence number, in an extension region other than the sequence number region,
and authentication information, which is generated based on the sequence number, in an authentication information region corresponding to the authentication information, and transmits the packet; and
a second communication device that receives the packet that includes the sequence number and the authentication information from the first communication device, and authenticates the received packet based on the sequence number and the authentication information included in the received packet.
